(19) United States
(12) Patent Application Publication
(10) Pub. No.: US 2025/0145825 A1
(43) Pub. Date: May 8, 2025

(54) POLYARYLENE SULFIDE RESIN COMPOSITION, MOLDED ARTICLE, AND METHODS FOR PRODUCING THESE

(71) Applicant: DIC Corporation, Tokyo (JP)

(72) Inventors: Keisuke Yamada, Ichihara-shi (JP); Taku Ibaraki, Ichihara-shi (JP); Toshio Hinokimori, Ichihara-shi (JP); Hirokiyo Nakase, Ichihara-shi (JP)

(73) Assignee: DIC Corporation, Tokyo (JP)

(21) Appl. No.: 18/694,037

(22) PCT Filed: Jun. 2, 2022
(86) PCT No.: PCT/JP2022/022423

§ 371 Date: Mar. 21, 2024

(30) Foreign Application Priority Data
Oct. 26, 2021 (JP) 2021-174570

(51) Int. Cl. C08L 81/02; C08G 75/0259; C08J 3/20; C08K 5/544

(52) U.S. Cl. CPC C08L 81/02; C08G 75/0259; C08J 3/201; C08K 5/544; C08J 2381/02; C08L 2207/04

(57) ABSTRACT

Provided is a PAS molded article in which an increase in tackiness due to retention is suppressed and generated gas is reduced. Specifically, provided are a PAS resin composition obtained by mixing a PAS resin with a thermoplastic elastomer and/or a silane coupling agent, wherein the PAS resin is a crosslinked PAS resin, and has a region where tan δ at 280° C. to 330° C. is less than 1 at an angular frequency 1/s in the measurement of dynamic viscoelasticity, the amount of the thermoplastic elastomer mixed is 12 parts by mass or less relative to 100 parts by mass of the PAS resin, and/or the amount of the silane coupling agent mixed is 1.0 part by mass or less relative to 100 parts by mass of the PAS resin, and the viscosity change rate is 150% or less, a molded article, and methods for producing these.

### TECHNICAL FIELD

The present invention relates to a polyarylene sulfide resin composition, a polyarylene sulfide resin molded article, and methods for producing these.

### BACKGROUND ART

In recent years, an engineering plastic having excellent productivity and moldability and high heat resistance has been developed. Since the engineering plastic is lightweight, the engineering plastic is widely used instead of a metal material for electric and electronic apparatuses and members of automobiles. In particular, a polyarylene sulfide (hereinafter referred to as PAS) resin typified by a polyphenylene sulfide (hereinafter referred to as PPS) resin has high heat resistance and excellent mechanical strength, chemical resistance, molding processability, and dimensional stability. Therefore, the PAS resin has been widely used in the fields of automobile parts, electric and electronic parts, parts used in a wet area, and the like.

On the other hand, for the parts used in a wet area to be in contact with water or an aqueous solution, there is a need for a material in which a reinforcing material, such as glass fibers, contained in a resin composition is prevented from being detached in the usage environment, and a highly tough material in which cracking and the like do not occur even in use for a long period. Thus, a resin composition containing a reduced amount of the reinforcing material and having high viscosity and high toughness has been increasingly required.

As a technique for improving the toughness of a PAS resin composition, for example, a technique for mixing an amino group-containing compound and an epoxy group-containing elastomer, like PTL 1, is known. However, in order to achieve practical toughness by a PAS resin composition containing no reinforcing material, a large amount of elastomer having lower heat resistance than the PAS resin is mixed, resulting in an increase in a decomposed gas generated in molding. This leads to a problem with processability, and particularly continuous moldability.

It is known that when the degree of crosslinking of a PAS resin is increased for enhancing the toughness, the resin in a melted state may remain due to an increase in the radical amount, and tackiness tends to be increased.

### CITATION LIST

### Patent Literature

PTL 1: Japanese Unexamined Patent Application Publication No. 2020-56007

### SUMMARY OF INVENTION

### Technical Problem

An object of the present invention is to provide a PAS molded article that is excellent in mechanical strength, particularly toughness, and a PAS resin composition that can form the molded article and has excellent processability in which an increase in tackiness due to retention is suppressed and generated gas is reduced, and methods for producing these.

### Solution to Problem

The inventors of the present invention have intensively studied to solve the aforementioned problems, as a result found that by combining a crosslinked PAS resin with a thermoplastic elastomer and/or a silane coupling agent in amounts of specific ranges, a PAS resin composition has excellent toughness and excellent processability in which an increase in tackiness due to retention is suppressed and generated gas is reduced, and completed the present invention.

In other words, the present disclosure relates to a PAS resin composition obtained by mixing a PAS resin (A) with a thermoplastic elastomer (B) and/or a silane coupling agent (C), in which the PAS resin (A) is a crosslinked PAS resin, and has a region where tan δ at 280° C. to 330° C. is less than 1 at an angular frequency 1/s in the measurement of dynamic viscoelasticity, the amount of the thermoplastic elastomer (B) mixed is 12 parts by mass or less relative to 100 parts by mass of the PAS resin (A), and/or the amount of the silane coupling agent (C) mixed is 1 part by mass or less relative to 100 parts by mass of the PAS resin (A), and the viscosity change rate is 150% or less.

The present disclosure relates to a molded article obtained by molding the PAS resin composition described above.

The present disclosure relates to a method for producing a PAS resin composition, the method including a step of mixing a PAS resin (A) with a thermoplastic elastomer (B) and/or a silane coupling agent (C) and melt-kneading the mixture at a temperature range equal to or higher than the melting point of the PAS resin (A), wherein the PAS resin (A) is a crosslinked PAS resin, and has a region where tan δ at 280° C. to 330° C. is less than 1 at an angular frequency 1/s in the measurement of dynamic viscoelasticity, the amount of the thermoplastic elastomer (B) mixed is 0.5 to 12 parts by mass relative to 100 parts by mass of the PAS resin (A), and the viscosity change rate is 150% or less.

Furthermore, the present disclosure relates to a method for producing a molded article, the method including steps of: producing a PAS resin composition by the method described above; and melt-molding the obtained PAS resin composition.

### Advantageous Effects of Invention

The present disclosure can provide a PAS molded article in which a thermoplastic elastomer or a silane coupling agent is mixed in a crosslinked PAS resin and that is excellent in mechanical strength, particularly toughness, and a PAS resin composition that can form the molded article and is excellent in processability, and methods for producing these.

### DESCRIPTION OF EMBODIMENTS

A PAS resin composition according to the present embodiment is obtained by mixing a PAS resin (A) with a thermoplastic elastomer (B) and/or a silane coupling agent (C). This will be described below.

### <Polyarylene Sulfide Resin (A)>

The PAS resin composition according to the embodiment contains a crosslinked PAS resin as an essential component.

The PAS resin has a resin structure containing as a repeating unit a structure in which an aromatic ring is bonded to a sulfur atom. Specifically, the PAS resin composition is a resin containing a structural moiety represented by the following general formula (1):

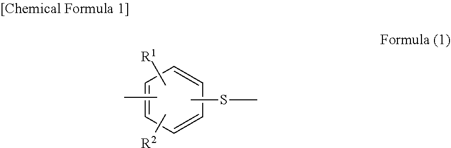

(wherein R¹ and R² are each independently a hydrogen atom, an alkyl group having 1 to 4 carbon atoms, a nitro group, an amino group, a phenyl group, a methoxy group, or an ethoxy group.) and if necessary, a trifunctional structural moiety represented by the following general formula (2):

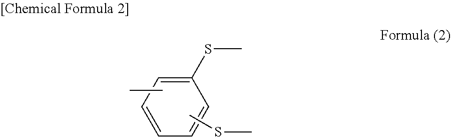

as repeating units. The amount of the trifunctional structural moiety represented by the formula (2) is preferably within the range of 0.001 to 3% by mole, and particularly preferably within the range of 0.01 to 1% by mole, relative to the total number of moles of other structural moieties.

Herein, the structural moiety represented by the formula (1), especially R¹ and R² in the formula are preferably a hydrogen atom in terms of mechanical strength of the PAS resin. In this case, examples of the structural moiety include a structural moiety represented by the following formula (3) and having bonds at para positions and a structural moiety represented by the following formula (4) and having bonds at meta positions.

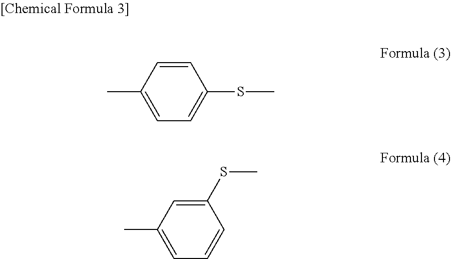

In particular, the structural moiety represented by the general formula (3) in which a bond of the aromatic ring to the sulfur atom in the repeating unit is a bond at a para position is preferable in terms of heat resistance and crystallinity of the PAS resin.

The PAS resin may contain not only the structural moieties represented by the formulae (1) and (2), but also structural moieties represented by the following structural formulae (5) to (8):

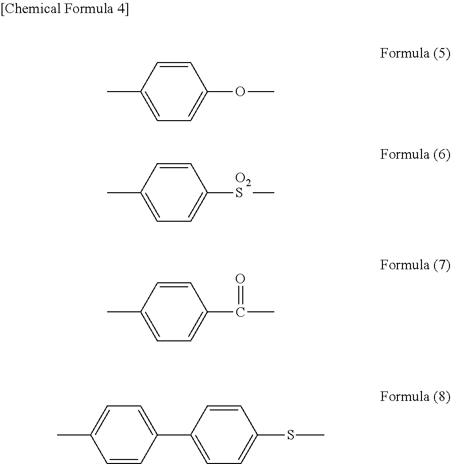

in an amount of 30% by mole or less relative to the total amount of the structural moieties represented by the formulae (1) and (2). In particular, in the present disclosure, it is preferable that the amount of the structural moieties represented by the general formulae (5) to (8) be 10% by mole or less in terms of heat resistance and mechanical strength of the PAS resin. When the PAS resin contains the structural moieties represented by the general formulae (5) to (8), the structural moieties may be bonded at any pattern to form any of a random copolymer or a block copolymer.

The molecular structure of the PAS resin may have a naphthyl sulfide bond and the like, and the amount thereof is preferably 3% by mole or less, and particularly preferably 1% by mole or less, relative to the total amount of the molecular structure and another structural moiety.

The physical properties of the PAS resin are not particularly limited as long as they do not impair the effects of the present invention, and are as described below.

### (Melt Viscosity)

The melt viscosity of the PAS resin used in the PAS resin composition of the present disclosure is not particularly limited. The melt viscosity (V6) measured at 300° C. is preferably 1, 000 Pa·s or more, and more preferably 1,500 Pa·s or more since toughness and mechanical strength are well balanced. In the measurement of the melt viscosity (V6), a flow tester CFT-500D manufactured by Shimadzu Corporation is used for the PAS resin. The melt viscosity is a value measured after the PAS resin is held at 300° C., a load of 1.96×106 Pa, and a L/D of 10 (mm)/1 (mm) for 6 minutes.

### (Non-Newtonian Index)

The non-Newtonian index of the PAS resin used in the PAS resin composition of the present disclosure is not particularly limited, and is preferably 1.5 or more, and more preferably 1.8 or more. Such a PAS resin has excellent mechanical physical properties, flowability, and abrasion resistance. In the present disclosure, the non-Newtonian index (N value) is a value calculated by the following equation from a shear rate (SR) and a shear stress (SS) that are measured using a capillary rheometer under conditions of a melting point plus 50° C. and a ratio L/D of an orifice length (L) to an orifice diameter (D) of 40. As the non-Newtonian index (N value) is closer to 1, the structure is closer to a linear shape. As the non-Newtonian index (N value) is higher, the structure is more branched.

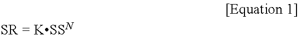

(wherein SR represents a shear rate (s-1), SS represents a shear stress (dyn/cm²), and K is a constant.)

### (Molecular Weight)

The PAS resin used in the PAS resin composition of the present disclosure is preferably one having a peak in a range where the molecular weight determined by gel permeation chromatography using as a solvent 1-chloronaphthalene is 40,000 or more. When the peak molecular weight of the PAS resin is within this range, the amount of a terminal of the molecule of the PAS resin is reduced to reduce the sodium content, and a sufficient mechanical strength is achieved in a resin molded article formed from the PAS resin composition. Therefore, this is preferable.

### (Zeta Potential)

The zeta potential at a pH of 7.8 to 8.2 of the PAS resin used in the PAS resin composition of the present disclosure that is measured by a streaming potential method is preferably-70 mV or more, and more preferably-65 mV or more. The zeta potential is preferably-50 mV or less, and more preferably-55 mV or less. The zeta potential of the PAS resin refers to the average value when a film (e.g., 5.0 cm in length, 3.0 cm in width, and 0.1 cm in thickness) in an amorphous state is produced from the resin and the zeta potential of the surface of the film is measured three times with SurPASS3 (Anton Paar) in a 1 mmol/L KCl aqueous solution that is an electrolytic liquid at a measurement temperature of 22 to 26° C.

### (Dissipation Factor)

For the PAS resin used in the PAS resin composition of the present disclosure, the temperature zone where the dissipation factor (tan δ) obtained by the measurement of dynamic viscoelasticity is less than 1 is 280° C. or higher and 330° C. or lower at an angular frequency 1/s. Generally, a material having larger tan δ, that is, higher loss elastic modulus (E″) is likely to be plastically deformed, while a material having smaller tan δ, that is, higher storage elastic modulus (E′) is likely to be elastically deformed.

The dissipation factor (tan δ) of the PAS resin used in the PAS resin composition of the present disclosure is a value (E″/E′) determined by measuring the dynamic viscoelasticity with a rheometer (e.g., rheometer “ARES-G2” manufactured by TA Instruments) under conditions of an angular frequency 1/s and a distortion of 0.1% at 220° C. to 330° C. and dividing the resulting loss elastic modulus (E″) by the storage elastic modulus (E′).

### (Production Method)

A method for producing the PAS resin is not particularly limited, and examples thereof include: (method 1) a method in which a dihaloaromatic compound, and if necessary, a polyhaloaromatic compound or another copolymerization component are polymerized in the presence of sulfur and sodium carbonate; (method 2) a method in which a dihaloaromatic compound, and if necessary, a polyhaloaromatic compound or another copolymerization component are polymerized in a polar solvent in the presence of an alkali metal sulfide and/or an alkali metal hydrosulfide (hereinafter also abbreviated as sulfide-forming agent) and the like; (method 3) a method for self-condensing p-chlorothiophenol with another copolymerization component if necessary; and (method 4) a method in which a diiodo aromatic compound and a simple substance sulfur are melt-polymerized under reduced pressure in the presence of a polymerization inhibitor that may have a functional group, such as a carboxy group and an amino group. Among these methods, the method 2 is preferable since it is widely used. During a reaction, an alkali metal salt of carboxylic acid or sulfonic acid, or an alkali hydroxide may be added to adjust the degree of polymerization. In the method 2, during a reaction, an alkali metal salt of carboxylic acid or sulfonic acid, or an alkali hydroxide may be added to adjust the degree of polymerization. In the method 2, a method in which a blend containing a dihaloaromatic compound, a polar organic solvent, and a sulfide-forming agent is placed in a reactor such that the molar ratio of (polar organic solvent)/(sulfide-forming agent) is within the range of 0.02/1 to 0.9/1, preferably a rise in temperature is initiated under an open system in an inert gas atmosphere, the blend is dehydrated, and with the progress of the dehydration, a solid material is deposed, to obtain a low moisture content solid material in which the components are uniformly dispersed, the system is cooled to a predetermined temperature, and if necessary, a polar organic solvent and/or a dihaloaromatic compound is further added to the low moisture content solid material, and polymerization is performed in an inert gas atmosphere (see Japanese Patent No. 3637543); and a method in which a dihaloaromatic compound, and if necessary, a polyhaloaromatic compound or another copolymerization component are reacted with an alkali metal hydrosulfide and an alkali metal salt of an organic acid in the presence of a solid alkali metal sulfide and an aprotic polar organic solvent while the amount of the alkali metal salt of an organic acid is controlled within the range of 0.01 to 0.9 moles relative to 1 mole of sulfur source and the amount of water in the reaction system is controlled to be 0.02 moles or less relative to 1 mole of the aprotic polar organic solvent (see WO2010/058713) are particularly preferable.

As the method for producing the PAS resin, a polymerization method using the method 2, more particularly, a step of obtaining a reaction mixture (slurry) containing the PAS resin by a reaction of at least one type of polyhaloaromatic compound with at least one type of sulfide-forming agent in a polar solvent (e.g., a polar organic solvent) under a proper polymerization condition will be described below as an example. The embodiment encompasses an embodiment in which a slurry is obtained by a reaction in the presence of the sulfide-forming agent and the organic solvent by continuous or intermittent addition of the polyhaloaromatic compound and/or the organic solvent.

The polyhaloaromatic compound used in the embodiment is, for example, a halogenated aromatic compound having two or more halogen atoms directly bonded to an aromatic ring, and specifically includes p-dihalobenzene, m-dihalobenzene, o-dihalobenzene, 2,5-dihalotoluene, 1,4-dihalonaphthalene, 1-methoxy-2,5-dihalobenzene, 4,4′-dihalobiphenyl, 3,5-dihalobenzoic acid, 2,4-dihalobenzoic acid, 2,5-dihalonitrobenzene, 2,4-dihalonitrobenzene, 2,4-dihaloanisole, p, p′-dihalodiphenyl ether, 4,4′-dihalobenzophenone, 4,4′-dihalodiphenyl sulfone, 4,4′-dihalodiphenyl sulfoxide, 4,4′-dihalodiphenyl sulfide, and compounds having an alkyl group having 1 to 18 carbon atom on the aromatic ring of any of the aforementioned compounds. The dihaloaromatic compound described above may be used alone, or two or more types thereof may be used in combination. Examples of the polyhaloaromatic compound other than the dihaloaromatic compound include 1,2,3-trihalobenzene, 1,2,4-trihalobenzene, 1,3,5-trihalobenzene, 1,2,3,5-tetrahalobenzene, 1,2,4,5-tetrahalobenzene, and 1,4,6-trihalonaphthalene. The compounds may be block-copolymerized. Among the specific examples, dihalogenated benzenes are preferable, and a compound containing 80% by mole or more of p-diclorobenzene is particularly preferable. The polyhaloaromatic compound may be used alone, or two or more types thereof may be used in combination. A halogen atom contained in each of the aforementioned haloaromatic compounds is preferably a chlorine atom and/or a bromine atom.

In order to increase the viscosity of the PAS resin due to a branched structure, a polyhaloaromatic compound having 3 or more halogen substituents in the molecule may be used as a branching agent, as desired. Examples of such a polyhaloaromatic compound include 1,2,4-trichlorobenzene, 1,3,5-trichlorobenzene, and 1,4,6-trichlorolnaphthalene.

Furthermore, examples thereof include polyhaloaromatic compounds having active hydrogen-containing functional groups such as an amino group, a thiol group, and a hydroxyl group. Specific examples thereof include dihaloanilines such as 2,6-dichloroaniline, 2,5-dichloroaniline, 2,4-dichloroaniline, and 2,3-dichloroaniline; trihaloanilines such as 2,3,4-trichloroaniline, 2,3,5-trichloroaniline, 2,4,6-trichloroaniline, and 3,4,5-trichloroaniline; dihaloamino diphenyl ethers such as 2,2′-diamino-4,4′-dichloro diphenyl ether, and 2,4′-diamino-2′,4-dichloro diphenyl ether; a mixtures thereof; and compounds in which the amino group in the aforementioned compounds is substituted by a thiol group or a hydroxyl group.

An active hydrogen-containing polyhaloaromatic compound in which a hydrogen atom bonded to a carbon atom forming an aromatic ring in the active hydrogen-containing polyhaloaromatic compounds is substituted by another inactive group, for example, a hydrocarbon group such as an alkyl group can also be used.

Among these various active hydrogen-containing polyhaloaromatic compounds, an active hydrogen-containing dihaloaromatic compound is preferable, and dichloroaniline is particularly preferable.

Examples of a polyhalogeno aromatic compound having a nitro group include mono- or dihalonitrobenzenes such as 2,4-dinitrochlorobenzene, and 2,5-dichloronitrobenzene; dihalonitro diphenyl ethers such as 2-nitro-4,4′-dichloro diphenyl ether; dihalonitrodiphenyl sulfones such as 3,3′-dinitro-4,4′-dichlorodiphenyl sulfone; mono- or dihalonitropyridines such as 2,5-dichloro-3-nitropyridine, and 2-chloro-3,5-dinitropyridine; and various dihalonitronaphthalenes.

Examples of the polar organic solvent include amides, ureas, and lactams, such as formamide, acetamide, N-methylformamide, N, N-dimethylacetamide, tetramethyl urea, N-methyl-2-pyrrolidone, 2-pyrrolidone, N-methyl-E-caprolactam, E-caprolactam, hexamethyl phosphoramide, N-dimethylpropylene urea, and 1,3-dimethyl-2-imidazolidinone acid; sulfolanes such as sulfolane and dimethyl sulfolane; nitriles such as benzonitrile; ketones such as methyl phenyl ketone, and mixtures thereof. Among these, amides having an aliphatic cyclic structure, such as N-methyl-2-pyrrolidone, 2-pyrrolidone, N-methyl-ε-caprolactam, ε-caprolactam, hexamethyl phosphoramide, N-dimethylpropylene urea, and 1,3-dimethyl-2-imidazolidinone acid are preferable, and N-methyl-2-pyrrolidone is more preferable.

Examples of the sulfide-forming agent used in the embodiment include an alkali metal sulfide and/or an alkali metal hydrosulfide.

The alkali metal sulfide includes lithium sulfide, sodium sulfide, rubidium sulfide, cesium sulfide, and a mixture thereof. Such an alkali metal sulfide can be used in a hydrate, aqueous mixture, or anhydride form. The alkali metal sulfide can be obtained by a reaction of an alkali metal hydrosulfide with an alkali metal hydroxide. For a reaction of a trace amount of alkali metal hydrosulfide or alkali metal thiosulfate present in the alkali metal sulfide, a small amount of alkali metal hydroxide may be usually added.

The alkali metal hydrosulfide includes lithium hydrosulfide, sodium hydrosulfide, rubidium hydrosulfide, cesium hydrosulfide, and a mixture thereof. Such an alkali metal hydrosulfide can be used in a hydrate, aqueous mixture, or anhydride form.

The alkali metal hydrosulfide is used with an alkali metal hydroxide. Examples of the alkali metal hydroxide include lithium hydroxide, sodium hydroxide, potassium hydroxide, rubidium hydroxide, and cesium hydroxide. The alkali metal hydroxides may be each used alone, or a mixture of two or more types thereof may be used. Among these, lithium hydroxide, sodium hydroxide, and potassium hydroxide are preferable, and sodium hydroxide is particularly preferable due to ease of availability.

The zeta potential value at a pH of 7.8 to 8.2 (e.g., pH=8.0) of the surface of a specimen that is an evaluation sample formed from at least a part of the PAS resin used in the PAS resin composition of the present disclosure is preferably within the range of-50 to-65 mV. Examples of a specific polymerization condition necessary for a tendency in which the zeta potential value at a pH of 7.8 to 8.2 (e.g., pH=8.0) of the surface of the specimen is within the range of-50 to-65 mV include the following conditions (a) to (c):
(a) the total amount of the organic solvent used from the preparation of a raw material to the completion of the polymerization reaction is preferably 1 to 6 mol relative to 1 mol of the sulfide-forming agent as the sulfur source;
(b) the amount of the organic solvent first prepared is preferably 0.01 to 0.50 mol relative to 1 mol of the sulfide-forming agent as the sulfur source; and
(c) to the PAS resin (or slurry) after the polymerization reaction, an acid or a hydrogen salt is preferably added. To the PAS resin (or slurry) after the polymerization reaction in a polymerization step, an acid or a hydrogen salt is more preferably added to adjust the pH of the reaction mixture to 7 to 11.

Examples of the acid in the condition (c) include organic acids including saturated fatty acids such as carbonic acid, oxalic acid, formic acid, acetic acid, propionic acid, butyric acid, valeric acid, caproic acid, and monochloroacetic acid, unsaturated fatty acids such as acrylic acid, crotonic acid, and oleic acid, aromatic carboxylic acids such as benzoic acid, phthalic acid, and salicylic acid, dicarboxylic acids such as oxalic acid, maleic acid, and fumaric acid, and sulfonic acids such as methanesulfonic acid and p-toluenesulfonic acid, and inorganic acids such as hydrochloric acid, sulfuric acid, sulfurous acid, nitric acid, nitrous acid, and phosphoric acid. Examples of the hydrogen salt in the condition (c) include sodium hydrogen sulfate, disodium hydrogen phosphate, and sodium hydrogen carbonate. For the use in a real device, an organic acid, which less corrodes a metal member, is preferable.

In the step of polymerizing the PAS resin of the embodiment, when the condition (a) is adopted, the concentration of the PAS resin in the polymerization is increased, and therefore a reaction that attaches a ring-opening product of an aliphatic cyclic compound to the terminal of the PAS easily proceeds. Therefore, a specific zeta potential value may be indicated. In the polymerization step in the embodiment, when the condition (b) is adopted, the concentration of the PAS resin in the polymerization is increased, and therefore a reaction that attaches a ring-opening product of an aliphatic cyclic compound to the terminal of the PAS easily proceeds. Therefore, a specific zeta potential value may be indicated. In the polymerization step in the embodiment, when the condition (c) is adopted, an acidic component is encapsulated in the PAS resin, and in a purification step, the acidic component oozes, and a part of a terminal functional group of the PAS resin is ion-exchanged and protonated. Therefore, a specific zeta potential value may be indicated.

In the embodiment, in order to make the zeta potential value at a pH of 7.8 to 8.2 (e.g., pH=8.0) of the surface of the specimen within the range of-50 to-65 mV, it is preferable that an acid be added to the PAS resin in the polymerization step or the purification step described below. Therefore, among the polymerization conditions (a) to (c), when the polymerization condition (c) is particularly satisfied, there is a strong tendency in which the zeta potential value is in the predetermined range.

A method for post-treating a reaction mixture containing the PAS resin obtained by a polymerization step is not particularly limited. Examples thereof include (post-treatment 1) a method in which after completion of a polymerization reaction, a solvent is distilled off under reduced pressure or normal pressure from the reaction mixture as it is or after addition of an acid or a base, a solid material after distillation of the solvent is washed with a solvent such as water, the reaction solvent (or an organic solvent having the same solubility in a low molecular weight polymer), acetone, methyl ethyl ketone, and an alcohol, one or two or more times, followed by neutralization, water-washing, filtration, and drying; (post-treatment 2) a method in which after completion of a polymerization reaction, a solvent (a solvent that is soluble in the solvent used for polymerization and is a poor solvent to at least PAS) such as water, acetone, methyl ethyl ketone, an alcohol, an ether, a halogenated hydrocarbon, an aromatic hydrocarbon, and an aliphatic hydrocarbon is added as a precipitating agent, to precipitate PAS and a solid product such as an inorganic salt, and they are filtered off, washed, and dried; (post-treatment 3) a method in which after completion of a polymerization reaction, a reaction solvent (or an organic solvent having the same solubility in a low molecular weight polymer) is added to the reaction mixture and then stirred, the low molecular weight polymer is removed by filtration, and the resultant is washed with a solvent such as water, acetone, methyl ethyl ketone, and an alcohol, one or two or more times, followed by neutralization, water-washing, filtration, and drying; (post-treatment 4) a method in which after completion of a polymerization reaction, water is added to wash the reaction mixture, and if necessary, an acid is added to treat the reaction mixture during water-washing, followed by filtration and drying; and (post-treatment 5) a method in which after completion of a polymerization reaction, the reaction mixture is filtered, and if necessary, washed with the reaction solvent one or two or times, and then washed with water, followed by filtration and drying. Among the methods, the method of the post-treatment 4 is preferable since a metal atom, such as sodium, present on the terminal of the molecule of the PAS resin can be effectively removed to obtain a PAS resin having a low sodium content.

In the post-treatment step, examples of a specific purification condition necessary for a tendency in which the zeta potential value at a pH of 7.8 to 8.2 (e.g., pH=8.0) of the surface of the specimen is within the range of −50 to −65 mV include the following conditions (d) to (f):
(d) it is preferable that a crude PAS resin be acid-treated with an acid solution in a predetermined amount or more, and it is more preferable that a crude PAS resin be acid-treated with an acid solution in an amount about two times the total weight of the PAS resin;
(e) it is preferable that the pH of the acid solution used in the acid treatment of (d) be 6 or less; and
(f) washing with hot water at 140 to 260° C. in an amount 1.5 to 10 times the total weight of the PAS resin is preferable.

In the post-treatment step, when any of the conditions (d) to (f) is adopted, the terminal functional group of the PAS resin can be protonated by an ion exchange reaction. The acid used in the acid solution is not particularly limited as long as an acid solution having a pH of 6 or less can be prepared. The acid in the condition (c) can be used.

In the post-treatment method described in the post-treatments 1 to 5, the PAS resin may be dried in vacuum, in an air, or in an inert gas atmosphere such as nitrogen.

A method for crosslinking a thus obtained PAS resin having a linear structure is not particularly limited as long as it is a publicly known method. Examples of the method include a method in which the granulated material is subjected to a heating treatment in an oxidative atmosphere such as air or oxygen rich air. From the viewpoint of improving a time required for the heating treatment and heat-stability during melting of the PAS resin after the heating treatment, a heating condition is preferably a temperature range of 180° C. or higher and a temperature lower than the melting point of the PAS resin by 20° C. Herein, the melting point is measured with a differential scanning calorimeter (e.g., DSC device Pyris Diamond manufactured by PerkinElmer Co., Ltd.) in accordance with JIS K 7121.

From the viewpoint of increasing the oxidation rate and shortening a treatment time, the oxygen concentration in the heating treatment in an oxidative atmosphere such as air or oxygen rich air is preferably 5% by volume or more, and more preferably 10% by mass or more. From the viewpoint of suppressing an increase in the amount of generated radical, suppressing an increase in tackiness during the heating treatment, and achieving favorable hue, the oxygen concentration may be preferably 30% by volume or less, and more preferably 25% by volume or less.

The PAS resin composition of the present disclosure is obtained by mixing the thermoplastic elastomer (B) and/or the silane coupling agent (C).

### <Thermoplastic Elastomer (B)>

Examples of the thermoplastic elastomer used in the present embodiment include a polyolefin-based elastomer, a fluorine-containing elastomer, and a silicone-based elastomer. Among these, a polyolefin-based elastomer is preferred. When the elastomer is added, the amount of the elastomer is not particularly limited as long as it does not impair the effects of the present invention. The amount of the elastomer mixed is preferably 0.5 parts by mass or more, and more preferably 1.0 part by mass or more, and preferably 12 parts by mass or less, and more preferably 5 parts by mass or less, relative to 100 parts by mass of the PAS resin (A). When it is within such a rage, the impact resistance of the obtained PAS resin composition is improved. Therefore, this is preferred.

Examples of the polyolefin-based elastomer include a homopolymer of α-olefin, a copolymer of two or more α-olefins, and a copolymer of one or two or more α-olefins with a vinyl polymerizable compound having a functional group. Examples of the α-olefins include α-olefins having 2 or more and 8 or less carbon atoms, such as ethylene, propylene, and 1-butene. Examples of the functional group include a carboxy group, an acid anhydride group (—C(═O) OC(═O)—), an epoxy group, an amino group, a hydroxyl group, a mercapto group, an isocyanate group, and an oxazoline group. Examples of the vinyl polymerizable compound having the functional group include one or two or more of vinyl acetate; an α,β-unsaturated carboxylic acid, such as (meth)acrylic acid; an alkyl ester of an α,β-unsaturated carboxylic acid, such as methyl acrylate, ethyl acrylate, and butyl acrylate; a metal salt of an α,β-unsaturated carboxylic acid, such as an ionomer (in which the metal is an alkali metal such as sodium, an alkaline earth metal such as calcium, zinc, or the like); a glycidyl ester of an α,β-unsaturated carboxylic acid, such as glycidyl methacrylate; an α,β-unsaturated dicarboxylic acid, such as maleic acid, fumaric acid, and itaconic acid; and a derivative (monoester, diester, acid anhydride) of the α,β-unsaturated dicarboxylic acid. The thermoplastic elastomer may be used alone, or two or more types thereof may be used in combination.

### <Silane Coupling Agent (C)>

The silane coupling agent used in the embodiment is not particularly limited. A silane-coupling agent having a functional group to be reacted with a carboxy group, such as an epoxy group, an isocyanato group, an amino group, or a hydroxyl group is preferred, and a silane coupling agent having an amino group is particularly preferred. Examples of such a silane-coupling agent include an epoxy group-containing alkoxysilane compound, such as γ-glycidoxypropyltrimethoxysilane, γ-glycidoxypropyltriethoxysilane, and β-(3,4-epoxycyclohexyl) ethyltrimethoxysilane, an isocyanato group-containing alkoxysilane compound, such as γ-isocyanatepropyltrimethoxysilane, γ-isocyanatepropyltriethoxysilane, γ-isocyanatepropylmethyldimethoxysilane, γ-isocyanatepropylmethyldiethoxysilane, γ-isocyanatepropylethyldimethoxysilane, γ-isocyanatepropylethyldiethoxysilane, and γ-isopropyltrichlorosilane, an amino group-containing alkoxysilane compound, such as γ-(2-aminoethyl) aminopropylmethyldiethoxysilane, γ-(2-aminoethyl) aminopropyltrimethoxysilane, and γ-aminopropyltrimethoxysilane, and a hydroxyl group-containing alkoxysilane compound, such as γ-hydroxypropyltrimethoxysilane, and γ-hydroxypropyltriethoxysilane.

The amount of the silane coupling agent used in the embodiment is not particularly limited as long as it does not impair the effects of the present invention. The amount of the silane coupling agent added is preferably 0.1 parts by mass or more, and more preferably 0.5 parts by mass or more, and preferably 1.0 part by mass or less, relative to 100 parts by mass of the PAS resin (A). When the amount is within such a range, the balance of the amount of generated gas and processability is excellent. Therefore, this is preferable.

Although the PAS resin composition of the present disclosure is a substantially unreinforced PAS resin composition, the PAS resin composition may contain a small amount of a filler as an optional component as long as the effects of the present invention are not impaired. As the filler, a commonly known material can be used as long as it does not impair the effects of the present invention. Examples thereof include a fibrous filler, a nonfibrous filler such as a plate-like filler, and fillers having various shapes. Specifically, a fibrous filler including natural fibers such as carbon fibers, ceramic fibers, aramid fibers, metal fibers, or fibers of potassium titanate or wollastonite can be used. A nonfibrous filler such as a glass flake, milled fibers, barium sulfate, clay, pyrophyllite, bentonite, sericite, mica, talc, attapulgite, ferrite, calcium silicate, zeolite, or calcium sulfate can be used. The amount of the filler mixed may be within the range that does not impair the effects of the present invention, and for example, is preferably 25 parts by mass or less, and more preferably 15 parts by mass or less, relative to 100 parts by mass of the PAS resin (A). When it is within such a rage, the resin composition exhibits favorable mechanical strength and moldability. Therefore, this is preferred. There is no possibility that when the filler is not contained (unreinforced), the filler is detached during use of a molded article. Therefore, this is particularly preferable.

In addition to the aforementioned components, according to use applications, the PAS resin composition of the present disclosure can further contain as an optional component a synthetic resin (hereinafter sometimes simply referred to as synthetic resin) such as a polyester resin, a polyamide resin, a polyimide resin, a polyetherimide resin, a polycarbonate resin, a polyphenylene ether resin, a polysulfone resin, a polyether sulfone resin, a polyetherether ketone resin, a polyether ketone resin, a polyarylene resin, a polyethylene resin, a polypropylene resin, a polytetrafluoroethylene resin, a polydifluoroethylene resin, a polystyrene resin, an ABS resin, a phenol resin, a urethane resin, or a liquid crystal polymer, as appropriate. In the present disclosure, the synthetic resin is not an essential component. When the synthetic resin is mixed, the amount of the synthetic resin mixed is not particularly limited as long as it does not impair the effects of the present invention. The amount varies according to the purpose thereof, and can be generally defined. For example, the amount of the synthetic resin mixed in the resin composition according to the present disclosure is within the range of 5 parts by mass or more and 15 parts by mass or less relative to 100 parts by mass of the PAS resin (A). In other words, the ratio by mass of the PAS resin (A) to the total amount of the PAS resin (A) and the synthetic resin is preferably 100/115 or more, and more preferably 100/105 or more.

Furthermore, the PAS resin composition of the present disclosure may contain as an optional component a commonly known additive such as a colorant, an antistat, an antioxidant, a heat-resistant stabilizer, an ultraviolet stabilizer, an ultraviolet absorber, a foaming agent, a flame retarder, a flame retardant promoter, an antirust agent, or a release agent (a metal salt or ester of fatty acid having 18 to 30 carbon atoms, including stearic acid or montanic acid, a polyolefin wax such as polyethylene, etc.), if necessary. The additive is not an essential component. The amount of the additive is preferably 0.01 parts by mass or more, and preferably 1, 000 parts by mass or less, more preferably 100 parts by mass or less, and further preferably 10 parts by mass or less, relative to 100 parts by mass of the PAS resin (A). The amount of the additive may be appropriately adjusted according to a purpose and use application for use without impairing the effects of the present invention.

The PAS resin composition of the present disclosure is characterized by having a viscosity change rate of 150% or less. The viscosity change rate of the resin composition in the present disclosure is a value calculated by the following equation using a melt viscosity measured at a shear rate of 12.16 sec-1 and 300° C. with a capillary rheometer (e.g., “Capilograph” manufactured by Toyo Seiki Seisaku-sho, Ltd.) under a condition of a L/D of an orifice of 40.

Viscosity change rate (%)=(melt viscosity after retention for 30 minutes (Pa·s)/melt viscosity after retention for 5 minutes (Pa·s))×100

A method for producing a PAS resin composition according to the embodiment is a method for producing a PAS resin composition, the method including a step of mixing the PAS resin (A) with the thermoplastic elastomer (B) and/or the silane coupling agent (C) and melt-kneading the mixture at a temperature range equal to or higher than the melting point of the PAS resin (A), wherein the PAS resin (A) is a crosslinked PAS resin, and has a region where tan δ at 280° C. or higher is less than 1 at an angular frequency 1/s, the amount of the thermoplastic elastomer (B) mixed is 0.5 to 12 parts by mass relative to 100 parts by mass of the PAS resin (A), and the viscosity change rate is 150% or less. The method will be described in detail below.

The method for producing the PAS resin composition of the present disclosure includes a step of mixing the aforementioned essential components and melt-kneading the mixture at a temperature range equal to or higher than the melting point of the PAS resin. More specifically, the PAS resin composition of the present disclosure contains each of the essential components and if necessary, the other optional component. Examples of the method for producing the resin composition used in the present disclosure include, but not particularly limited to, a method in which the essential components and if necessary, the optional component are mixed and melt-kneaded, and specifically, are mixed uniformly under drying by a tumbler, a Henschel mixer, or the like, if necessary, and then supplied to a twin-screw extruder and melt-kneaded.

Melt-kneading can be performed under heating within a temperature range at which the resin temperature is equal to or higher than the melting point of the PAS resin (A), a temperature range at which the resin temperature is preferably equal to or higher than the melting point plus 10° C., and a temperature range at which the resin temperature is more preferably equal to or higher than the melting point plus 10° C. or still more preferably equal to or higher than the melting point plus 20° C., and preferably equal to or lower than the melting point plus 100° C. or still more preferably equal to or lower than the melting point plus 50° C.

From the viewpoint of dispersibility and productivity, it is preferable that a melt-kneader be a twin-screw kneading extruder. For example, it is preferable that melt-kneading be performed while the amount of resin component discharged is controlled within the range of 5 to 500 (kg/hr) and the screw rotational speed is controlled within the range of 50 to 500 (rpm) as appropriate, and it is further preferable that melt-kneading be performed under a condition in which the ratio (the amount/the rotational speed) is within the range of 0.02 to 5 (kg/hr/rpm). Each of the components may be added to the melt-kneader and mixed simultaneously or separately. For example, when the glass fibers (B) as the essential component among the components, and if necessary, the other fibrous filler is added, it is preferable that they be supplied to the extruder from a side feeder of the twin-screw kneading extruder from the viewpoint of dispersibility. The side feeder is positioned such that the ratio of the distance between a resin-supplying portion (top feeder) of the extruder and the side feeder to the full length of screw of the twin-screw kneading extruder is preferably 0.1 or more, and more preferably 0.3 or more. The ratio is preferably 0.9 or less, and more preferably 0.7 or less.

The PAS resin composition of the present disclosure thus obtained by melt-kneading is a melt-kneaded mixture containing the essential components, and the optional component and a component derived from the optional component added, if necessary. Therefore, the PAS resin composition of the present disclosure has morphology in which the PAS resin forms a continuous phase and the other essential component and the optional component are dispersed. It is preferable that after the melt-kneading, a publicly known method be performed, for example, the PAS resin composition according to the present disclosure in a melted state be extrusion molded into a strand shape and then processed in a form of pellet, chip, granule, powder, or the like, and if necessary, pre-dried within the temperature range of 100 to 150° C.

A molded article according to the embodiment is formed by melt-molding the PAS resin composition. A method for manufacturing the molded article according to the embodiment includes a step of melt-molding the PAS resin composition. Therefore, the molded article of the present disclosure has morphology in which the PAS resin (A) forms a continuous phase and the other essential component and the optional component are dispersed. Since the PAS resin composition has such morphology, a molded article that is excellent in chemical resistance, particularly fuel barrier properties, and mechanical strength, particularly toughness is obtained.

The PAS resin composition of the present disclosure may be subjected to various types of molding, such as injection molding, compression molding, composite, sheet, or pipe extrusion molding, drawing molding, blow molding, and transfer molding. The PAS resin composition is particularly suitable for application of injection molding due to excellent mold releasability. Under molding by injection molding, each molding condition is not particularly limited. The PAS resin composition can be molded usually by a general method. For example, after the step of melting the PAS resin composition in an injection molding machine such that the resin temperature is equal to or higher than the melting point of the PAS resin (A), preferably equal to or higher than the melting point by 10° C., more preferably within the range of the melting point plus 10° C. to the melting point plus 100° C., and further preferably within the range of the melting point plus 20° C. to the melting point plus 50° C., the PAS resin composition may be injected into a mold from a resin discharge port and molded. In this case, the mold temperature may be set within a publicly known temperature range, for example, to room temperature (23° C.) to 300° C., and preferably 130° C. to 190° C.

The method for producing the molded article of the present disclosure may include a step of annealing the molded article. In the annealing, an optimal condition is selected depending on the use application, the shape, and the like of the molded article, and the annealing temperature is equal to or higher than the glass transition temperature of the PAS resin (A), preferably equal to or higher than the glass transition temperature plus 10° C., and more preferably equal to or higher than the glass transition temperature plus 30° C. The annealing temperature is preferably 260° C. or lower, and more preferably 240° C. or lower. Although the annealing time is not particularly limited, the annealing time is preferably 0.5 hours or more, and more preferably 1 hour or more. The annealing time is preferably 10 hours or less, and more preferably 8 hours or less. When it is within such a rage, the strain of the obtained molded article is reduced, the crystallinity of the resin is improved, and the mechanical properties are further enhanced. Therefore, this is preferable. The annealing may be performed in air, and preferably in an inert gas such as a nitrogen gas.

The PAS resin molded article of the present disclosure is excellent in toughness and processability, and is particularly suitable for parts in direct contact with a liquid or a steam thereof, that is, parts for fuel or parts for an area using water. Examples thereof include pipes for transporting a fluid and various parts attached to the pipes, such as a pipe, a lining pipe, a cap nut, a pipe joint (an elbow, a header, a cheese, a reducer, a joint, a coupler, and the like), various valves, a flowmeter, and a gasket (a seal and a packing). Specifically, the molded article can be suitably used for parts for an area using water, such as a water heater and a water amount sensor and temperature sensor for a bath, and in-vehicle parts for fuel, such as a fuel tank, a fuel tube, a fuel sensor, a fuel pump, a vane pump, an auto ratio flowmeter. In addition to the aforementioned parts, the molded article of the present disclosure can be used for usual resin molded articles described below. Examples thereof include electrical and electronic parts typified by box-shaped protecting and supporting members for electrical and electronic part integrated modules, a plurality of separate semiconductors or modules, a sensor, a LED lamp, a connector, a socket, a resistor, a relay case, a switch, a coil bobbin, a capacitor, a variable capacitor case, a light pickup, an oscillator, various terminal plates, a transformer, a plug, a printed board, a tuner, a speaker, a microphone, a headphone, a compact motor, a magnetic head base, a power module, a terminal stand, a semiconductor, a liquid crystal, a FDD carriage, a FDD chassis, a motor brush holder, a parabola antenna, and a computer-related part; home and office electrical product parts typified by a VTR part, a television part, an iron, a hair dryer, a rice cooker part, a microwave oven part, an acoustic part, an audio apparatus part such as an audio laser disk, a compact disk, a DVD disk, and a blue ray disk, an illumination part, a refrigerator part, an air conditioner part, a typewriter part, a word processor part, and a part for an area using water; machine-related parts typified by an office computer-related part, a telephone-related part, a facsimile-related part, a copying machine-related part, a jig for cleaning, a motor part, a lighter, and a typewriter; optical instruments and precision machine-related parts typified by a microscope, a binocular, a camera, and a clock; and automobile and vehicle-related parts such as an alternator terminal, an alternator connector, a brush holder, a slip ring, an IC regulator, a potentiometer base for light dimmer, a relay block, an inhibitor switch, various valves such as an exhaust gas valve, various fuel-related, outlet, and inlet pipes, an air intake nozzle snorkel, an intake manifold, an engine cooling water joint, a carburetor main body, a carburetor spacer, an exhaust gas sensor, a cooling water sensor, a hot water temperature sensor, a brake pad wear sensor, a throttle positioner, a crankshaft positioner, a thermal sensor, an air flow meter, a brake pad wear sensor, an air conditioner thermostat base, a hot-air flow control valve, a brush holder for a radiator motor, a water pump impeller, a turbine vane, a wiper motor-related part, a distributor, a starter switch, an ignition coil and a bobbin thereof, a motor insulator, a motor rotor, a motor core, a starter relay, a wire harness for transmission, a wind washer nozzle, an air conditioner panel switch board, a coil for a fuel-related electromagnetic valve, a fuse connector, a horn terminal, an electrical part insulation plate, a stepper motor rotor, a lamp socket, a lamp reflector, a lamp housing, a brake piston, a solenoid bobbin, an engine oil filter, and an ignition device case. The PAS resin molded article can be adopted in various use applications.

### EXAMPLES

Hereinafter, the present disclosure will be described using Examples and Comparative Examples. However, the disclosure is not limited to Examples. Hereinafter, “%” and “part(s)” are based on mass unless other specified.

### Examples 1 to 7 and Comparative Examples 1 to 4

Materials were mixed in accordance with composition components and mixing amounts listed in Table 1. The materials were supplied to a twin-screw extruder with a vent “TEX30α (product name)” manufactured by The Japan Steel Works, Ltd., and melt-kneaded at a resin component discharge amount of 30 kg/hr, a screw rotation speed of 200 rpm, and a set resin temperature of 320° C., to obtain pellets of a resin composition. Glass fibers and carbon fibers were supplied from a side feeder (S/T ratio: 0.5), and other materials were uniformly mixed in a tumbler in advance and then supplied from a top feeder. The obtained pellets of the resin composition were dried in a Geer oven at 140° C. for 2 hours, and then injection-molded to produce various specimens. The specimens were subjected to the following tests.

### <Evaluation>

### (1) Measurement of Tensile Elongation at Break

The obtained pellets were supplied to an injection molding apparatus (SE-75D-HP) manufactured by Sumitomo Heavy Industries, Ltd., in which a cylinder temperature was set to 310° C., and injection-molded using an ISO Type-A dumbbell specimen molding mold in which the mold temperature was adjusted to 140° C., to obtain an ISO Type-A dumbbell specimen. In the production, the resin was injected from a single gate such that the specimen did not contain a weld part. For the obtained dumbbell specimen, the tensile elongation at break (%) was measured by a measurement procedure in accordance with ISO 527-1 and 2. The results are shown in Table 1.

### (2) Measurement of Viscosity Change Rate

For the obtained pellets of the resin composition, the melt viscosity was measured with a capillary rheometer (“Capilograph D1” manufactured by Toyo Seiki Seisaku-sho, Ltd.) under conditions of a shear rate of 12.16 sec⁻¹, 300° C., and a L/D of 40. The viscosity change rate was calculated by the following equation. The results are shown in Table 1.

Viscosity change rate (%)=(melt viscosity after retention for 30 minutes (Pa·s)/melt viscosity after retention for 5 minutes (Pa·s))×100

### (3) Measurement of Weight Loss (Generated Gas Amount)

4.00 g of PPS powder sample was weighed on an aluminum dish with a precision balance. The sample was allowed to stand in a drying machine set at 150° C. for 1 hour, and the dish was taken out, cooled to room temperature, and weighed. Subsequently, the dish was allowed to stand in a drying machine set at 325° C. for 1 hour, taken out, cooled to room temperature, and then weighed. The weight loss of the sample was calculated by the following equation. The results are shown in Table 1.

Weight loss (wt %)=(weighed value (g) after heating at 150° C.-weighed value (g) after heating at 370° C.)/weighed value (g) after heating at 150° C.×100

TABLE 1

| | | | Ex. | Ex. | Ex. | Ex. | Ex. | Ex. | Ex. | Comp. | Comp. | Comp. | Comp. |
|---|---|---|---|---|---|---|---|---|---|---|---|---|---|
| | | | 1 | 2 | 3 | 4 | 5 | 6 | 7 | Ex. 1 | Ex. 2 | Ex. 3 | Ex. 4 |
| Composition | A-1 | wt % | 95 | | 99.5 | 99.5 | 95 | 95 | 99.5 | 100 | 99.7 | | |
| | A-2 | wt % | | 95 | | | | | | | | | |
| | A-3 | wt % | | | | | | | | | | 95 | 80 |
| | B-1 | wt % | 5 | 5 | 0.5 | | | | | | 0.3 | 5 | 20 |
| | B-2 | wt % | | | | | 5 | | | | | | |
| | B-3 | wt % | | | | | | 5 | | | | | |
| | C-1 | wt % | | | | 0.5 | | | | | | | |
| | C-2 | wt % | | | | | | | 0.5 | | | | |
| Evaluation | Tensile | % | 35 | 22 | 31 | 31 | 32 | 31 | 31 | 30 | 31 | 18 | 30 |
| | elongation | | | | | | | | | | | | |
| | at break | | | | | | | | | | | | |
| | Viscosity | % | 111 | 106 | 137 | 148 | 106 | 111 | 101 | 980 | 250 | 95 | 87 |
| | change | | | | | | | | | | | | |
| | rate | | | | | | | | | | | | |
| | Weight | wt % | 0.8 | 0.7 | 0.3 | 0.3 | 0.7 | 0.7 | 0.3 | 0.3 | 0.3 | 0.5 | 2.3 |
| | loss | | | | | | | | | | | | |

As the mixing components in Table 1, the followings were used.
A-1: crosslinked PPS resin (melt viscosity (V6): 2,800 Pa·s, tan δ at 280 to 310° C.: less than 1, zeta potential:-56 mV, non-Newtonian index: 2.3)
A-2: crosslinked PPS resin (melt viscosity (V6): 1500 Pa·s, tan § at 280 to 300° C.: less than 1, zeta potential:-60 mV, non-Newtonian index: 2.1)
a-3: linear PPS resin (melt viscosity (V6): 120 Pa·s, tan δ at 275 to 330° C.: constantly 1 or more, zeta potential: −66 mV, non-Newtonian index: 1.1)

### (Production Example 1) Production of PPS Resins (A-1 to a-3)

### [Step 1]

In a 150-L autoclave having a stirrer blade connected to a pressure gauge, a thermometer, a condenser, a decanter, and a rectification tower, 33.222 kg (226 moles) of p-dichlorobenzene (hereinafter abbreviated as “p-DCB”), 4.560 kg (46 moles) of NMP, 27.300 kg (in terms of NaSH, 230 moles) of 47.23% by mass NaSH aqueous solution, and 18.533 g (in terms of NaOH, 228 moles) of 49.21% by mass NaOH aqueous solution were placed, heated to 173° C. over 5 hours with stirring in a nitrogen atmosphere, to distill 26.794 kg of water. The autoclave was then closed. p-DCB distilled by azeotropy during the dehydration was separated by the decanter, and at any time, was brought back to the autoclave. In the autoclave after completion of the dehydration, fine particles of anhydrous sodium sulfide composition were dispersed in p-DCB. The NMP content in this composition was 0.089 kg (0.9 moles). This shows that 98% (45.1 moles) of the placed NMP was hydrolyzed into a SMAB. The amount of SMAB in the autoclave was 0.196 moles per mole of sulfur atom present in the autoclave. The theoretical amount of water removed when the placed NaSH and NaOH were all changed into anhydrous Na₂S was 27.921 g. This shows that 812 g (45.1 moles) of water out of 1, 127 g (62.6 moles) of residual water in the autoclave was consumed by the hydrolysis reaction of NMP with NaOH, and thus this water was not present and the remaining 315 g (17.5 moles) of water or water of crystallization remained in the autoclave. The amount of water in the autoclave was 0.076 moles per mole of sulfur atom present in the autoclave.

### [Step 2]

After completion of the aforementioned dehydration step, the inner temperature was cooled to 160° C., 45.203 kg (456 moles) of NMP was placed and heated to 185° C. The amount of water in the autoclave was 0.038 moles per mole of NMP placed at the step 2. When the gauge pressure reached 0.00 MPa, a valve connected to the rectification tower was opened, and the inner temperature was heated to 200° C. over one hour. At that time, the outlet temperature of the rectification tower was controlled to be 110° C. or lower by cooling and a valve opening degree. The mixed vapor of distilled p-DCB and water was condensed by the condenser, and separated by the decanter, and the p-DCB was brought back to the autoclave. The amount of distilled water was 273 g (15.2 moles).

### [Step 3]

At the start of the step 3, the amount of water in the autoclave was 42 g (2.3 moles), 0.005 moles per mole of NMP placed in the step 2, or 0.010 moles per mole of sulfur atom present in the autoclave. The amount of SMAB in the autoclave was 0.196 moles per mole of sulfur atom present in the autoclave, which was the same as in the step 1. Subsequently, the inner temperature was heated from 200° C. to 230° C. over 3 hours, stirred at 230° C. for 3 hours, heated to 250° C., and stirred for 1 hour. The gauge pressure at an inner temperature of 200° C. was 0.03 MP, and the final gauge pressure was 0.50 MPa. After cooling, 650 g of slurry obtained was poured in 3 L of water, stirred at 80° C. for 1 hour, and then filtered. The resultant cake was stirred with 3 L of hot water for 1 hour, washed, and then filtered. This operation was repeated 4 times. To the resultant cake, 3 L of hot water and acetic acid were added to adjust the pH to 4.0, and the mixture was stirred for 1 hour, washed, and then filtered. The resultant cake was stirred with 3 L of hot water for 1 hour, washed, and then filtered. This operation was repeated 2 times. The resultant was dried with a hot air dryer at 120° C. overnight, to obtain a PPS resin (a-3) as a white powder. The melt viscosity at 300° C. of this polymer was about 120 Pa·s. The obtained PPS resin was thermally crosslinked in an oxidizing atmosphere at 210 to 250° C. to a target viscosity, to obtain crosslinked PPS resins (A-1) and (A-2).
B-1: thermoplastic elastomer (LOTADER AX-8930 manufactured by ARKEMA K.K.)
B-2: thermoplastic elastomer (LOTADER AX-8390 manufactured by ARKEMA K.K.)
B-3: thermoplastic elastomer (Engage 8842 manufactured by Dow Chemical Company)
C-1: silane coupling agent (γ-glycidoxypropyltrimethoxysilane)
C-2: silane coupling agent (3-aminopropyltriethoxysilane)

As recognized from comparison of Examples with Comparative Examples, all the toughness, the viscosity change rate (rate of increase in tackiness during resistance), and the weight loss (amount of generated gas) of the materials in Examples are well balanced and excellent.

1. A polyarylene sulfide resin composition obtained by mixing a polyarylene sulfide resin (A) with a thermoplastic elastomer (B) and/or a silane coupling agent (C), wherein
the polyarylene sulfide resin (A) is a cross-linked polyarylene sulfide resin, and has a region where tan δ at 280° C. to 330° C. is less than 1 at an angular frequency 1/s in measurement of dynamic viscoelasticity,
an amount of the thermoplastic elastomer (B) mixed is 12 parts by mass or less relative to 100 parts by mass of the polyarylene sulfide resin (A), and/or an amount of the silane coupling agent (C) mixed is 1.0 part by mass or less relative to 100 parts by mass of the polyarylene sulfide resin (A), and
a viscosity change rate is 150% or less (provided that the viscosity change rate is calculated by an equation below using a melt viscosity measured at a shear rate of 12.16 sec-1 and 300° C. with a capillary rheometer)
Viscosity change rate (%)=(melt viscosity after retention for 30 minutes (Pa·s)/melt viscosity after retention for 5 minutes (Pa·s))×100.

2. The polyarylene sulfide resin composition according to claim 1, wherein a zeta potential at a pH of 7.8 to 8.2 of the polyarylene sulfide resin (A) measured by a streaming potential method is-70 mV or more.

3. The polyarylene sulfide resin composition according to claim 1, wherein the silane coupling agent (C) has an amino group.

4. The polyarylene sulfide resin composition according to claim 1, wherein the polyarylene sulfide resin composition is a melt-kneaded product.

5. A molded article obtained by melt-molding the polyarylene sulfide resin composition according to claim 1.

6. A method for producing a polyarylene sulfide resin composition, the method comprising a step of mixing a polyarylene sulfide resin (A) with a thermoplastic elastomer (B) and/or a silane coupling agent (C) and melt-kneading the mixture at a temperature range equal to or higher than a melting point of the polyarylene sulfide resin (A), wherein
the polyarylene sulfide resin (A) is a cross-linked polyarylene sulfide resin, and has a region where tan δ at 280° C. to 330° C. is less than 1 at an angular frequency 1/s in measurement of dynamic viscoelasticity,
an amount of the thermoplastic elastomer (B) mixed is 0.5 to 12 parts by mass relative to 100 parts by mass of the polyarylene sulfide resin (A), and
a viscosity change rate is 150% or less (provided that the viscosity change rate is calculated by an equation below using a melt viscosity measured at a shear rate of 12.16 sec-1 and 300° C. with a capillary rheometer)
Viscosity change rate (%)=(melt viscosity after retention for 30 minutes (Pa·s)/melt viscosity after retention for 5 minutes (Pa·s))×100.

7. The method for producing a polyarylene sulfide resin composition according to claim 6, wherein a zeta potential at a pH of 7.8 to 8.2 of the polyarylene sulfide resin (A) measured by a streaming potential method is-70 mV or more.

8. The method for producing a polyarylene sulfide resin composition according to claim 6, wherein the silane coupling agent (C) has an amino group.

9. A method for producing a molded article comprising a step of melt-molding the polyarylene sulfide resin composition according to claim 1.

10. A component obtained by melt-molding the polyarylene sulfide resin composition according to claim 1, wherein the component is to be in direct contact with water or a steam thereof.

11. The polyarylene sulfide resin composition according to claim 2, wherein the silane coupling agent (C) has an amino group.

12. The polyarylene sulfide resin composition according to claim 2, wherein the polyarylene sulfide resin composition is a melt-kneaded product.

13. The polyarylene sulfide resin composition according to claim 3, wherein the polyarylene sulfide resin composition is a melt-kneaded product.

14. A molded article obtained by melt-molding the polyarylene sulfide resin composition according to claim 2.

15. A molded article obtained by melt-molding the polyarylene sulfide resin composition according to claim 3.

16. The method for producing a polyarylene sulfide resin composition according to claim 7, wherein the silane coupling agent (C) has an amino group.

17. A method for producing a molded article comprising a step of melt-molding the polyarylene sulfide resin composition according to claim 2.

18. A method for producing a molded article comprising a step of melt-molding the polyarylene sulfide resin composition according to claim 3.

19. A component obtained by melt-molding the polyarylene sulfide resin composition according to claim 2, wherein the component is to be in direct contact with water or a steam thereof.

20. A component obtained by melt-molding the polyarylene sulfide resin composition according to claim 3, wherein the component is to be in direct contact with water or a steam thereof.
